(19) United States
(12) Patent Application Publication
(10) Pub. No.: US 2006/0087485 A1
(43) Pub. Date: Apr. 27, 2006

(54) Electro-optic device

(75) Inventor: Moriyuki Tsuchihashi, Kanagawa-ken (JP)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/254,157

(22) Filed: Oct. 19, 2005

(30) Foreign Application Priority Data
Oct. 26, 2004 (JP) 2004-310982

(51) Int. Cl. G09G 3/36

(52) U.S. Cl. 345/98

(57) ABSTRACT

Disclosed is a drive circuit for an electro-optic device which includes a plurality of scan lines, a plurality of data lines, and a plurality of pixel circuits arranged corresponding to intersections between each of the scan lines and each of the data lines. The drive circuit includes a compensation voltage outputting circuit which, corresponding to a plurality of representative data lines selected out of the plurality of data lines, outputs compensation voltages which are obtained by compensating for differences in voltage characteristics among pixel circuits corresponding to the representative data lines; a reference voltage distributing circuit for outputting a plurality of reference voltages on the basis of at least two of the compensation voltages; and a data voltage outputting circuit for outputting data voltages based on the reference voltages respectively to the data lines.

### TECHNICAL FIELD

This invention relates to a drive circuit for an electro-optic device, the electro-optic device, an electronic appliance, and a drive method of the electro-optic device.

### BACKGROUND

A liquid crystal display device has been heretofore known as an example of an electro-optic device. This liquid crystal display device includes a display unit, a drive circuit and an adjustment circuit. The display unit is arranged in an intersection between each of a plurality of scan lines and each of a plurality of data lines, and consequently the display units are arranged in a matrix. Each of the display units includes pixel circuits such as a thin film transistor (hereinafter referred to as a “TFT”) and a display electrode. The drive circuit supplies a voltage to the TFT. The adjustment circuit is provided to each of the drive circuits, and adjusts a reference voltage in response to an influence of the TFT and display electrode parasitic capacity on an electrode voltage of the TFT. Reference may be had, for example, Japanese Patent Laid-open Official Gazette No. Hei. 11-133919.

In the case of this liquid crystal display device, a scan voltage with a pulse waveform is supplied to a gate of the TFT in order to supply voltage from the data line to a display electrode. When the TFT is turned into an “on” state by the supplying of the scan voltage, the voltage of the data line is supplied to the display electrode. When the TFT is in an “off” state, the display electrode is going to hold this voltage. At this point, the TFT has parasitic capacity. Accordingly, in a case where the TFT transits from the “on” state to the “off” state, the voltage of the display electrode is reduced in conjunction with decrease in a gate drive voltage (punch-through voltage). The voltage thus reduced is held. In other words, a voltage to be held by the display electrode while the TFT is in the “off” state becomes lower than a voltage to be supplied from the data line. At this point, the punch-through voltage varies depending on where the TFT is positioned. This reduction of the voltage causes a deviation between a center voltage to be applied to the display electrode when the display electrode is AC-driven and a common voltage to be applied to an opposing electrode opposite to the display electrode. This brings about a cause for flickering and unevenness of the display screen.

According to a configuration disclosed in Japanese Patent Laid-open Official Gazette No. Hei. 11-133919, the adjustment circuit detects a difference between a drain voltage of each of the TFTs and the common voltage, thus adjusting the reference voltage which is supplied to the drive circuit. This inhibits a deviation between the center voltage to be applied to the display electrode when the display electrode is AC-driven and the common voltage to be applied to the display electrode.

However, in the case of this configuration, the adjustment circuit which detects the difference between the drain voltage of the TFT and the common electrode, and which thus adjusts the reference voltage, is needed for each of the data lines. In addition, the configuration also requires wiring which carries the drain voltage of the TFT and the common voltage from the pixel circuits to the adjustment circuits. It is likely that this will cause the display unit and the drive circuit to become larger.

### SUMMARY OF THE INVENTION

The foregoing and other problems are overcome, and other advantages are realized, in accordance with exemplary embodiments of this invention.

Exemplary embodiments of this invention provide a drive circuit for an electro-optic device, the electro-optic device including the drive circuit, an electronic appliance, and a drive method of the electro-optic device, all of which can solve the aforementioned problem.

The present invention provides a drive circuit for an electro-optic device, the electro-optic device, an electronic appliance, and a drive method of the electro-optic device. The drive circuit for the electro-optic device includes: a plurality of scan lines; a plurality of data lines; and an array of pixel circuits comprised of a plurality of pixel circuits arranged corresponding to intersections between each of the scan lines and each of the data lines. The drive circuit for the electro-optic device includes a compensation voltage outputting circuit, a reference voltage distributing circuit and a data voltage outputting circuit. The compensation voltage outputting circuit outputs compensation voltages, corresponding to a plurality of representative data lines selected out of the plurality of data lines, which compensation voltages being obtained by compensating for differences in voltage characteristics among pixel circuits corresponding to the plurality of representative data lines. The reference voltage distributing circuit outputs a plurality of reference voltages on the basis of at least two of the compensation voltages. The data voltage outputting circuit outputs data voltages based on the reference voltages respectively to the data lines.

According to the electro-optic device, the compensation voltage outputting circuit outputs compensation voltages which are obtained by compensating for differences in voltage characteristics among the pixel circuits corresponding to the plurality of representative data lines selected out of the plurality of data lines. The reference voltage distributing circuit outputs the plurality of reference voltages on the basis of at least two of the compensation voltages. This does not require an adjustment circuit for detecting a voltage of each of the pixel circuits and the wiring to be provided to each of the data lines, and enables the difference in voltage characteristics between each two of the pixel circuits to be reduced.

Accordingly, the use of this invention enables bulkiness of the display unit and the drive circuit to be avoided, and concurrently enables the flickering and unevenness of the display screen to be reduced.

A method is disclosed, in accordance with the exemplary embodiments of this invention, to drive an electro-optic device that is comprised of a plurality of scan lines, a plurality of data lines, and an array of pixel circuits individual ones of which correspond to intersections between individual ones of the scan lines and individual ones of the data lines. The method includes outputting compensation voltages generated to compensate for differences in voltage characteristics among pixel circuits corresponding to locations of pixel circuits within the array of pixel circuits; outputting a plurality of reference voltages on the basis of at least two of the compensation voltages and outputting data voltages based on the reference voltages respectively to the data lines.

### BRIEF DESCRIPTION OF THE DRAWINGS

For a more complete understanding of the present invention and the advantages thereof, reference is now made to the following description taken in conjunction with the accompanying drawings, where:

FIG. 1 is a block diagram showing an entire configuration of a liquid crystal display device 10.

FIG. 2 is a diagram showing an equivalent circuit of a pixel circuit 110.

FIG. 3 is a diagram showing a voltage waveform of a gate of a TFT 111 and a voltage waveform of a display electrode of a pixel capacity 112 in the pixel circuit 110.

FIG. 4 is a graph showing a relationship between a position of a transistor arranged in a scan line and a decreased voltage of an electrode of the pixel capacity 112.

FIG. 5 is a diagram showing a data line drive circuit 200.

FIG. 6 is a graph showing a relationship between each of positions respectively of selected representative data lines and corresponding one of compensation voltages.

FIG. 7 is a diagram showing a circuit of each D/A converter group 250.

FIG. 8 is a diagram showing a circuit of each D/A converter 260.

FIG. 9 is a graph showing a relationship between the position of the transistor arranged in the scan line and a voltage of the electrode of the pixel capacity 112.

FIG. 10 is a diagram showing a personal computer 500 to which the liquid crystal display device 10 is applied.

### DETAILED DESCRIPTION OF THE INVENTION

Descriptions will be provided for an electro-optic device including a drive circuit according to an embodiment of the present invention, giving an example of a liquid crystal display device, with reference to the drawings.

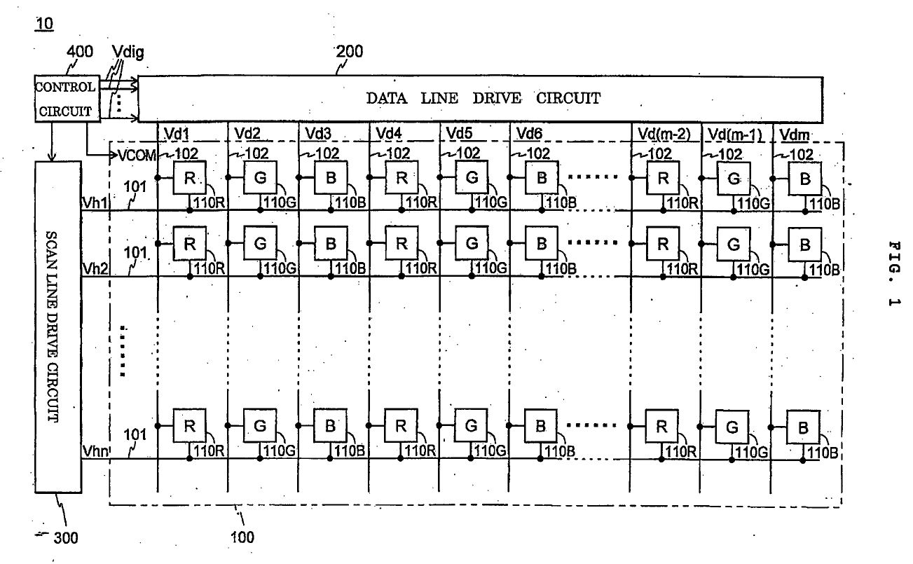

FIG. 1 is a block diagram showing an entire configuration of a liquid crystal display device 10. This liquid crystal display device includes a liquid crystal panel 100, a data line drive circuit 200 as a drive circuit, a scan line drive circuit 300, and a control circuit 400. The liquid crystal panel 100 is provided with a plurality of scan lines 101 and a plurality of data lines 102. A plurality of pixel circuits 110 (110R, 110 G and 110B) are arranged in a matrix of n rows×m columns, respectively in response to intersections among the scan lines 101 and the data lines 102. The number of the pixel circuits 110 is, for example, 768 rows×3,072 columns.

Each of the pixel circuits 110 are sub-pixels corresponding to any of R color, G color and B color. One pixel is constituted of an R color sub-pixel, a G color sub-pixel and a B color sub-pixel. In FIG. 1, pixel circuits 110R, 110G and 11B correspond respectively to R color, G color, and B color.

The data line drive circuit 200 supplies the data lines 102 respectively with drive voltages Vd1, Vd2, . . . , and Vdm. The drive voltages Vd1, Vd2, . . . , and Vdm are voltage signals to be applied respectively to display electrodes of the pixel circuits 110, and are determined by digital input data Vdig. The drive voltages Vd1, Vd2, . . . , and Vdm are taken up by the pixel circuits 110 in a row selected by the scan line drive circuit 300.

The scan line drive circuit 300 generates scan signals Vh1, Vh2, . . . , and Vhn for scanning the plurality of scan lines 101 sequentially. The scan line drive circuit 300 supplies the scan signals Vh1, Vh2, . . . , and Vhn respectively to the scan lines 101. The scan signal Vh1 is a pulse with a width equivalent to one horizontal scan period which begins at a first timing during one vertical scan period. The scan signal Vh1 is supplied to the scan line 101 in a first row. Subsequently, this pulse is shifted sequentially. The pulse thus shifted is supplied, sequentially as scan signals Vh2, . . . , and Vhn, respectively to the scan lines 101 in a second, a third, . . . , and an nth rows.

If any one of the scan signals supplied respectively to the plurality of scan lines 101 were at an “H” level, a scan line to which this scan signal has been supplied is selected.

The control circuit 400 generates, and outputs, digital input data Vdig to be supplied to the data line drive circuit 200. In addition to this, the control circuit 400 generates, and outputs, various control signals for controlling the data line drive circuit 200 and the scan line drive circuit 300. Furthermore, the control circuit 400 outputs a common voltage VCOM to be supplied to a common electrode.

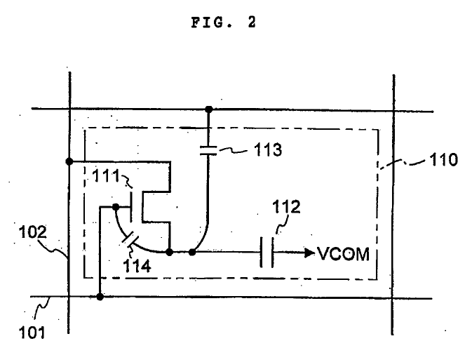

FIG. 2 is a diagram showing an equivalent circuit of the pixel circuit 110. The pixel circuit 110 includes a thin film transistor 111 (hereinafter, referred to as a “TFT”) as a switching element, a pixel capacity 112, and an auxiliary capacity 113. A gate of the TFT is connected to the scan line 101, and a source of the TFT is connected to the data line 102. The pixel capacity 112 is constituted of the display electrode and the common electrode opposite to the display electrode. Liquid crystal is interposed between, and supported by, the display electrode and the common electrode. The display electrode of the pixel capacity 112 is connected to a drain of the TFT 111. The common voltage VCOM from the control circuit 400 is applied to the common electrode. The auxiliary capacity 113 is connected to the drain of the TFT 111, and to a scan line 101 adjacent to the scan line 101 to which the gate of the TFT 111 is connected. The TFT 111 has a parasitic capacity 114 between the gate and the drain.

At this point, descriptions will be provided for a decrease in voltage of the display electrode due to reduction of gate voltage, what is termed as a punch-through voltage, which is a difference in voltage characteristics between each two of the pixel circuits 110 arranged in each of the scan lines 101.

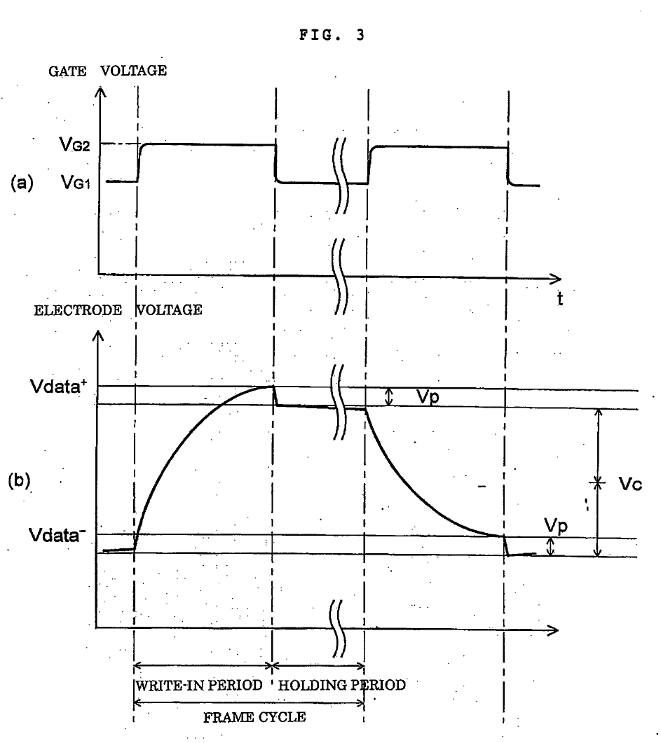

FIG. 3 is a diagram showing a voltage waveform of the gate of the TFT 111 and a voltage waveform of the display electrode of the pixel capacity 112 in the pixel circuit 110. When the scan line drive circuit 300 outputs a scan signal Vh1 with a pulse waveform to the scan line 101, the gate voltage of the TFT 111 rises from VG1 to VG2, and accordingly the TFT is turned into an “on” state. Under this condition, a voltage Vdata⁺applied to the source through the data line 102 is supplied to the pixel capacity 112 through the drain. Accordingly, the electrode voltage of the pixel capacity 112 rises. During transition to a holding period, if the gate voltage falls from VG2 to VG1, the electrode voltage decreases by Vp due to the parasitic capacity 114 between the gate and the drain. The Vp is termed as a “punch-through voltage.” During the holding period, a voltage to be applied after this voltage fall is held. In this manner, the voltage to be held by the electrode is lower than the voltage to be supplied by the data line drive circuit due to the punch-through voltage. The punch-through voltage varies depending on a gradient of the decreasing gate voltage, or depending on a fall time of the pulse waveform. The sharper the gradient is, the larger the punch-through voltage is.

The voltage to be applied to the source of the TFT 111 is reversely driven alternately between Vdata⁺ and Vdata⁻ in each frame cycle. Reference symbol Vc in the graph denotes a median value of the voltage to be reversely driven during the holding period.

Returning now to FIG. 1, the gates respectively of the TFTs 111 are connected in a line to each of the scan lines 101 from a corresponding output terminal of the scan line drive circuit 300, or from the left in the diagram. The number of the TFTs 111 corresponds to the number of the data lines 102. These scan lines 101 and these TFTs 111 cause distributed resistance and distributed capacity. For this reason, the farther a TFT 111 is away from corresponding one of the output terminals of the scan line drive circuit, the larger the roundness of a pulse waveform to be supplied to the gate is. In other words, a gradient of decrease in gate voltage of a transistor positioned farther away from the corresponding one of the output terminals of the scan line drive circuit is more moderate than a gradient of decrease in gate voltage of a transistor positioned closer to the corresponding one of the output terminals of the scan line drive circuit. Consequently, the punch-through voltage varies depending on where in the scan line the transistor is positioned. Accordingly, the voltage held by the electrode of the pixel capacity 112 varies.

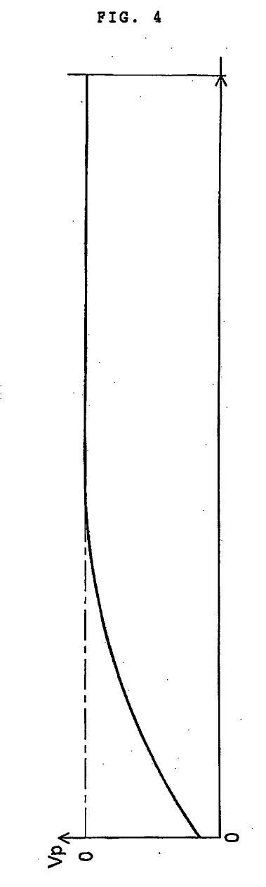

FIG. 4 is a graph showing a relationship between a position of a transistor arranged in a scan line and a decreased voltage Vp of the electrode of the pixel capacity 112. This graph shows a difference in voltage characteristics between one pixel circuit 110 and another, both of which correspond to different data lines 102. The horizontal axis of the graph indicates a distance of a TFT 111 arranged in a scan line from a position of corresponding one of the output terminals of the scan line drive circuit 300, or a position of the TFT 111 in the scan line. For example, the right end of the graph means a position the farthest away from the output terminal of the scan line drive circuit 300, or a position at the right end of the liquid crystal panel 100 as shown in FIG. 1. At this point, as shown by the graph in FIG. 4, the voltage Vp of the pixel capacity 112 to be decreased due to the punch-through voltage is the largest at the position of the output terminal of the scan line drive circuit 300. The farther away from the output terminal of the scan line drive circuit 300, or the farther to the right of the graph, the smaller the voltage Vp of the pixel capacity 112 to be decreased due to the punch-through voltage is. The relationship between the position of the TFT 111 and the decreased voltage Vp represents no linear characteristics. A rate of change in the punch-through voltage is the largest in the output terminal of the scan line drive circuit 300. As the position of the TFT comes away from the output terminal, the rate of change in the punch-through voltage comes closer to a certain value O.

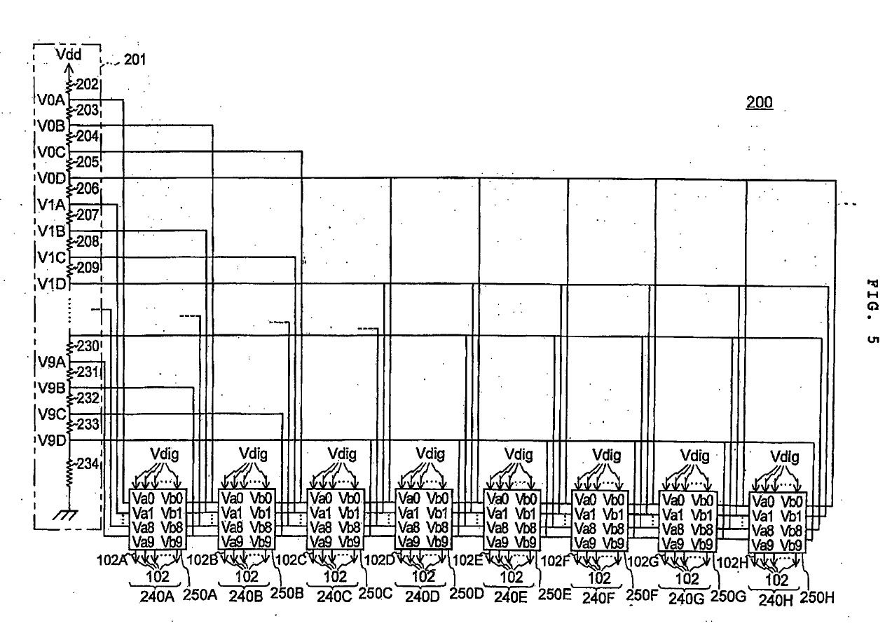

FIG. 5 is a diagram showing the data line drive circuit 200. The data line drive circuit 200 includes a plurality of D/A converter groups 250 (250A, 250B, 250C, . . . , and 250H) and a compensation voltage outputting circuit 201. Each of the plurality of D/A converter group 250 supplies drive voltages to data lines 102. The compensation voltage outputting circuit 201 supplies the plurality of D/A converter groups 250 with compensation voltages V0A, V0B, V0C, V0D, V1A, V1B, V1C, V1D, V2A, . . . , V8D, V9A, V9B, V9C and V9D. Incidentally, compensation voltages V2A, V2B, . . . , and V8D are omitted from FIG. 5.

The D/A converter groups 250 output to the data lines 102 the drive voltages Vd1, . . . , and Vdm based on the digital input signal Vdig. At this point, a plurality of data lines 102 constitute each of data line groups 240 (240A, 240B, . . . , and 240H). The D/A converter groups 250 are arranged along an array of corresponding data line groups 240. For example, the D/A converter group 250A corresponds to the data line group 240A including a data line 102 which is the closest to the output terminal of the scan line drive circuit 300. The D/A converter groups 250B, 250C, . . . , and 250H correspond respectively to neighboring data line groups 240B, 240C, . . . , and 240H.

In each of the D/A converter groups 250, the upper limit value of the drive voltages to be outputted to the data lines 102 is determined by voltages to be inputted as two compensation voltages Va0 and Vb0. In addition, the lower limit value of the drive voltages to be outputted to the data lines 102 is determined by voltages to be inputted as other two compensation voltages Va9 and Vb9. Furthermore, an intermediate value of the drive voltages to be outputted to the data lines 102 is determined by voltages to be inputted as other compensation voltages Va1, Vb1, Va2, Vb2, . . . , Va8 and Vb8. For example, the compensation voltages V0A and V0B are inputted as the compensation voltages Va0 and Vb0 of the D/A converter group 250A. Accordingly, the upper limit value of the drive voltages to be outputted to the data lines 102 of the data line group 240A by the D/A converter group 250A is determined by a voltage between V0A and V0B.

The compensation voltage outputting circuit 201 includes a plurality of divided resistances 202, 203, 204, . . . , and 234. The resistance divides the power supply voltage Vdd, and thus generates the compensation voltages V0A, V0B, V0C, V0D, V1A, . . . , and V9D. The divided resistances are connected in series. At this point, the compensation voltages V0A, V0B, V0C and V0D determine the upper limit voltage to be outputted to the data lines 102 by the D/A converter groups 250. In addition, the compensation voltages V9A, V9B, V9C and V9D determine the lower limit voltage to be outputted to the data lines 102 by the D/A converter groups 250. The D/A converter groups 250 output, in response to the digital input signal Vdig, voltages between the upper limit value and the lower limit value to be supplied from the compensation voltage outputting circuit 201.

A plurality of representative data lines 102A, 102B, . . . , and 102H are selected out of the plurality of data lines 102. In the case of this embodiment, data lines 102 which are the closest to the output terminals of the scan line drive circuit 300 respectively in the data line groups 240A, . . . , and 240H are selected as the representative data lines 102A, 102B, . . . , and 102H. The compensation voltages V0A, V0B, V0C and V0D are set so as to be compensation voltages which are obtained by compensating respectively for differences in voltage characteristics among pixel circuits corresponding to the representative data lines 102A, 102B, . . . , and 102H. Incidentally, the voltage characteristics due to the punch-through voltage respectively in positions of the representative data lines 102D, 102E, . . . , and 102H arranged in the right of the diagram are almost equal to one another. Consequently, the compensation voltage V0D corresponds to the representative data lines 102D, 102E, . . . , and 102H.

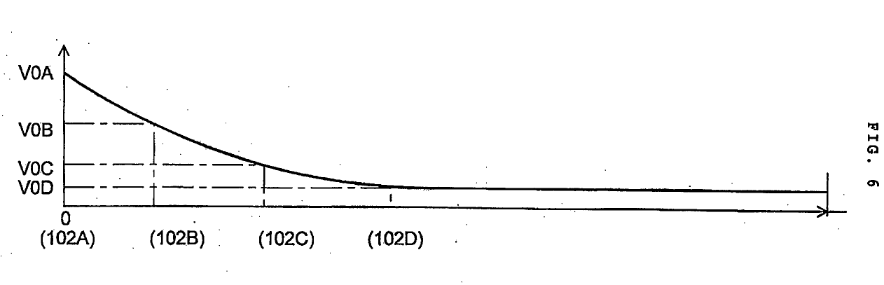

FIG. 6 is a graph showing a relationship between each of positions respectively of the selected representative data lines and corresponding one of the compensation voltages. The compensation voltages exhibit characteristics of compensating for decrease in voltage of the pixel capacities 112 due to the punch-through voltage. Specifically, the characteristics which are exhibited by the compensation voltages are characteristics which compensate for the characteristics as shown in FIG. 4. For example, V0D represents the upper limit value of a voltage to be outputted to a data line 102 in a position the farthest away from the output terminal of the scan line drive circuit 300. While V0D is defined as a reference, V0A is obtained by adding to V0D a punch-through voltage of a pixel circuit corresponding to a data line the closest to the output terminal of the scan line drive circuit 300. V0B and V0C are found in the same manner.

The divided resistances 202, 203, 204, . . . , and 234 of the compensation voltage outputting circuit 201 are set in a way that voltages corresponding to positions respectively of the representative data lines 102A, 102B, . . . , and 102H are outputted as the compensation voltages V0A, V0B, V0C and V0D in FIG. 6.

FIG. 6 shows characteristics respectively of the compensation voltages which determine the upper limit of the voltages to be outputted to the data lines 102. However, compensation voltages which determine the lower limit of the voltages to be outputted to the data lines 102 are set in the same manner. In addition, the divided resistances 202, 203, 204, . . . , and 234 are set in a way that voltages corresponding to positions respectively of the representative data lines 102A, 102B, . . . , and 102H are outputted as the compensation voltages V9A, V9B, V9C and V9D. Furthermore, characteristics respectively of compensation voltages which determine an intermediate voltage between the upper limit voltage and the lower limit voltage are set also in the same manner. The divided resistances are set in a way that voltages corresponding to positions respectively of the representative data lines 102A, 102B, . . . , and 102H are outputted as the compensation voltages V1A, V1B, V1C, V1D, . . . , V8A, V8B, V8C and V8D.

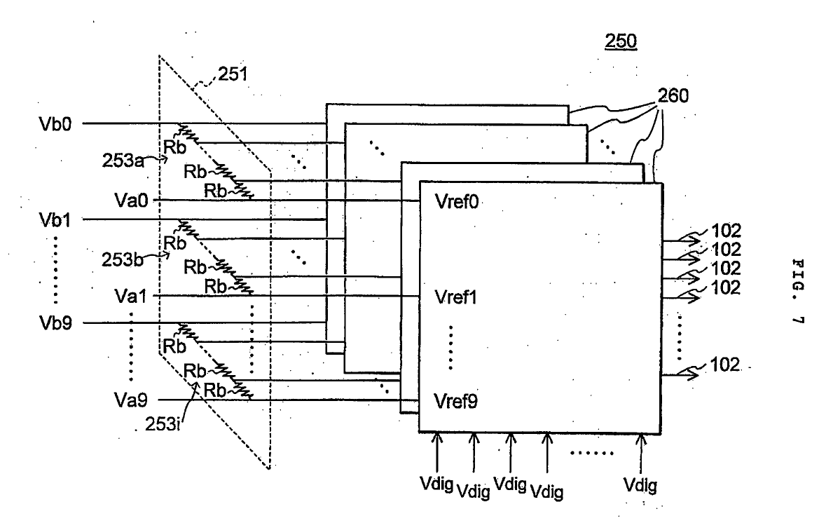

FIG. 7 is a diagram showing a circuit of each of the D/A converter groups 250. Each of the D/A converter groups 250 includes a plurality of D/A converters 260 as data voltage outputting circuits and a reference voltage distributing circuit 251. The reference voltage distributing circuit 251 inputs at least two compensation voltages Va0 and Vb0, and outputs a reference voltage Vref0 to the plurality of D/A converters 260 on the basis of the inputted compensation voltages. In addition, the reference voltage distributing circuit 251 outputs a reference voltage Vref9 to the plurality of D/A converters 260 on the basis of other two compensation voltages Va9 and Vb9. Furthermore, the reference voltage distributing circuit 251 outputs reference voltages Vref1, Vref2, . . . , and Vref8 to the plurality of D/A converters 260 on the basis of the respective pairs of compensation voltages Va1 and Vb1, Va2 and Vb2, . . . , as well as Va8 and Vb8.

Each of the D/A converters 260 is a multi-channel input-output D/A converter. For example, each of the D/A converters 260 can input 48 channels of digital input signals Vdig, and can output voltage values corresponding to the digital input signals respectively to 48 data lines 102. Each of the D/A converter groups 250 includes, for example, 8 D/A converters 260. In the case of this embodiment, consequently, each of the D/A converter groups 250 can output data voltages to 144 data lines 102 which are an equivalent to a data line group 240. Incidentally, FIG. 7 illustrates four of the D/A converters 260, and omits the others. The reference voltages Vref0, Vref1, . . . , and Vref9 are supplied to each of the D/A converters 260. The reference voltage Vref0 determines the upper limit of voltages which each of the D/A converters 260 can output, and the reference voltage Vref9 determines the lower limit of voltages which each of the D/A converters 260 can output. The reference voltages Vref1, Vref2, . . . , and Vref8 determine the intermediate value between the upper limit voltage and the lower limit voltage which each of the D/A converters 260 outputs.

The reference voltage distributing circuit 251 includes a plurality of divided resistance groups 253 (253a, 253b, . . . , and 253i). Each of the divided resistance groups 253 includes a plurality of divided resistances Rb which are connected in series. For example, the divided resistance group 253a generates a plurality of voltages on the basis of the two inputted compensation voltages Va0 and Vb0, and distributes the plurality of voltages as the reference voltages Vref0 respectively of the plurality of D/A converters 260. In addition, the divided resistance group 253b generates a plurality of voltages on the basis of the two inputted compensation voltages Va1 and Vbl, and distributes the plurality of voltages as the reference voltages Vref1 respectively of the plurality of D/A converters 260. This reference voltage distributing circuit 251 generates an intermediate voltage between two types of compensation voltages, and supplies the intermediate voltage as a reference voltage to each of the D/A converters 260. This makes smooth voltage compensation characteristics among the D/A converters 260. Incidentally, all of the divided resistances Rb according to this embodiment are equal to one another. For this reason, the plurality of D/A converter groups 250 which share the same circuit configuration can be arranged in a well-balanced manner.

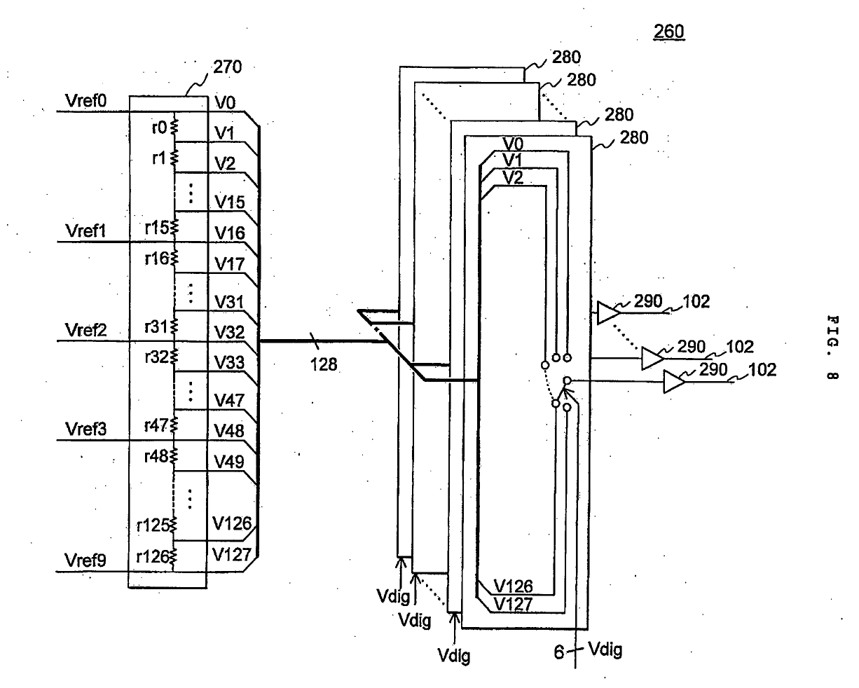

FIG. 8 is a diagram showing a circuit of each of the D/A converters 260. Each of the D/A converters 260 includes a gradient voltage generating unit 270, a plurality of selector circuits 280, and a buffer 290. The gradient voltage generating unit 270 inputs the reference voltages Vref0, Vref1, . . . , and Vref9, and generates gradient voltages V0, V1, . . . , and V127. The plurality of selector circuits 280 selects a voltage corresponding to the digital input signal Vdig out of the gradient voltages thus generated, and outputs the voltage. The buffer 290 drives the data lines 102 with the voltage thus outputted. In the case of this embodiment, the gradient voltages generated by the single gradient voltage generating unit 270 are supplied to the plurality of selector circuits 280. In other words, each of the D/A converters 260 is a multi-channel input-output D/A converter which shares the gradient voltage generating unit 270 among the selector circuits 280.

The gradient voltage generating unit 270 includes resistances r0, r1, . . . , and r126 which are connected in series. The gradient voltage generating unit 270 divides the reference voltages Vref0 and Vref9, and thus generates the gradient voltages V0, V1, . . . , and V127. At this point, the resistances r0, r1, . . . , and r126 are different in resistance value from one another. As a result, voltage differences among the gradient voltages V0, V1, . . . , and V127 are different from one another. The resistance values respectively of the resistances r0, r1, . . . , and r126 are set in a way that the gradient voltages V0, V1, . . . , and V127 generated through voltage division represent characteristics of compensating for the voltage-brightness characteristics (gamma characteristics) of the liquid crystal display device. Moreover, the gradient voltage generating unit 270 inputs the reference voltage Vref0 which is an upper limit reference voltage for determining the upper limit of the outputted voltages, and the reference voltage Vref9 which is a lower limit reference voltage for determining the lower limit of the outputted voltages. In addition to the reference voltages Vref0 and Vref9, the gradient voltage generating unit 270 inputs reference voltages Vref1, . . . , and Vref8 as the intermediate reference voltages which are intermediate reference voltages between the upper limit voltage and the lower limit voltage. Thus, the gradient voltage generating unit 270 adjusts the voltage distribution among the gradient voltages V0, V1, . . . , and V127. The configuration which enables the intermediate reference voltages Vref1, . . . , and Vref8 to be imputed makes it possible to adjust the voltage distribution among the gradient voltages V0, V1, . . . , and V127 in a dynamic manner not only with the resistances r0, r1, . . . , and r126 but also with voltages inputted from the outside. This enables voltage values to be changed, thus enabling the image quality to be fine tuned, even after the liquid crystal display device 10 including the resistances r0, r1, . . . , and r126 has been manufactured.

Each of the selector circuits 280 selects a voltage corresponding to the digital input signal out of the gradient voltages V0, V1, . . . , and V127, and outputs the voltage. The digital input signal Vdig is, for example, a 6-bit digital signal. One out of the 128 gradient voltages V0, V1, . . . , and V127 is selected with the 6-bit digital signal. Incidentally, the gradient voltage V0, V1, . . . , and V63 are higher than the common voltage VCOM to be applied to the common electrode, and the gradient voltages V64, V65, . . . , and V127 are voltage values lower than that of the common voltage VCOM. The drive voltages Vd1, Vd2, . . . , and Vdm respectively of the data lines are written into the display electrodes respectively of the pixel circuits 110. The voltage of each of the display electrodes is reversed about the common voltage VCOM in each frame period. For example, the voltages V0 and V127 are alternately outputted from one frame period to another.

The buffer 290 drives the data lines 102 with voltages outputted respectively from the selector circuits 280. The buffer 290 has a high input impedance. Accordingly, the buffer 290 prevents the gradient voltages V0, V1, . . . , and V127 as well as the reference voltages Vref0, Vref1, . . . , and Vref9 from fluctuating due to change of selected outputted voltages.

Returning now to FIGS. 6 and 7, the reference voltage distributing circuit 251 of the D/A converter group 250A supplies the compensation voltage V0A corresponding to the data line group 240A as Va0, and supplies the compensation voltage V0B corresponding to the data line group 240B adjacent to the data line group 240A as Vb0. The D/A converter group 250A generates 8 voltages in the range between the two types of compensation voltages with the divided resistance groups 253, and supplies the 8 voltages as Vref0 to the 8 D/A converters 260. In this manner, 8 different voltage values in the range between the compensation voltage V0A corresponding to the data line group 240A and the compensation voltage V0B corresponding to the adjacent data line group 240B are supplied as the reference voltage Vref0 to the 8 D/A converters 260. With regard to each of the other pairs of compensation voltages Va1 and Vb1, Va2 and Vb2, . . . , as well as Va9 and Vb9, the same process is performed. In this manner, 8 different voltages corresponding respectively to 8 different reference voltages are outputted respectively from the 8 D/A converters 260.

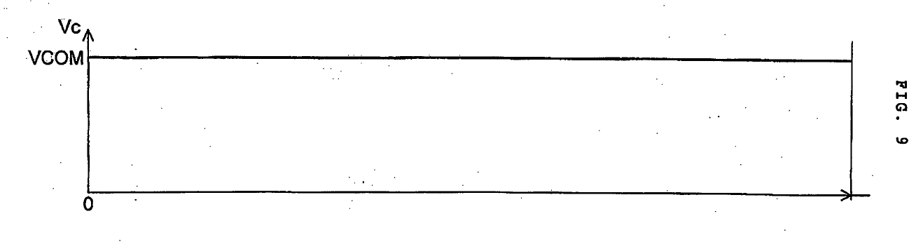

FIG. 9 is a graph showing a relationship between a position of a transistor arranged in a scan line and a voltage of an electrode of a pixel capacity 112. This graph shows a median value Vc of the electrode voltages respectively of the pixel capacities 112 which are alternately reversely driven in a case where digital input data alternately reversed in each frame period is supplied to the pixels. As described above, the voltage of each of the display electrodes becomes lower than corresponding one of the data line drive voltages due to the punch-through voltage. The farther away from the left of the screen, or the closer to the right of the screen, the smaller a degree of this decrease becomes. On the other hand, each of the data line drive voltages has compensation characteristics that, the farther away from the left of the screen, or the closer to the right of the screen, the smaller the data line drive voltage becomes. Accordingly, these are offset by each other. This makes the voltage of each of the display electrodes constant, irrespective of where each of the display electrodes is positioned in the screen. Consequently, the median voltages Vc of voltages respectively of the display electrodes which are alternately reversely driven in each frame period can be made constant, irrespective of where the display electrodes are in the screen. If the median voltage Vc were set so as to be the common voltage VCOM of the common electrode, the voltage of each of the display electrodes is alternately reversely driven in each frame period with the voltage VCOM of the common electrode defined as the median value. This enables flickering to be reduced without providing each of the data lines with a circuit for detecting a difference between corresponding one of the drain voltages and the common voltage.

In the case of the aforementioned liquid crystal display device 10, the compensation voltage outputting circuit 201 outputs, in response to a plurality of representative data lines 102A, . . . , and 102H, the compensation voltages V0A, V0B, V0C and V0D which are obtained by compensating for difference in voltage characteristics among the pixel circuits 110 corresponding to the plurality of representative data lines 102A, . . . , and 102H selected out of the plurality of data lines 102. The reference voltage distributing circuit 251 outputs a plurality of reference voltages, for example, Vref0 on the basis of at least two of the compensation voltages, for example, V0A and V0B which are inputted respectively as Va0 and Vb0 to the D/A converter group 250A. The compensation voltage outputting circuit 201 outputs the compensation voltages respectively in response to only the selected representative data lines. The reference voltage distributing circuit 251 generates the reference voltages Vref0 on the basis of the two compensation voltages corresponding to the respective representative data lines, and distributes the reference voltages Vref0 as reference voltages of each of the D/A converters 260. This enables differences in voltage characteristics among the pixel circuits to be reduced with a simple configuration, without making the display unit and the drive circuits bulky through providing each of the data lines with a circuit for detecting the voltage respectively of the pixel circuits and the related wiring.

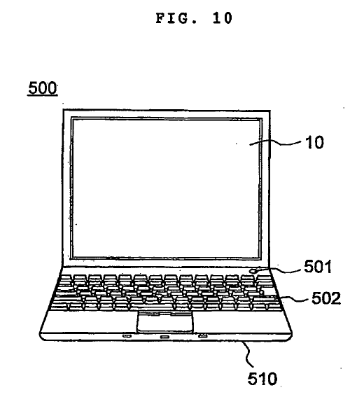

Hereinbelow, descriptions will be provided for an electronic appliance to which the liquid crystal display device 10 according to the aforementioned embodiment is applied. FIG. 10 shows a configuration of a personal computer to which the liquid crystal display device 10 is applied. The personal computer 500 includes the liquid crystal display device 10 as a display unit, and a main unit 510. The main unit 510 is provided with a power switch 501 and a keyboard 502. The liquid crystal display device 10 reduces flickering with a configuration having the data line drive circuit 200 which is simplified, thus enabling a highly fine image to be displayed with little flickering.

It should be noted that, as an electronic appliance to which the liquid crystal display device 10 is applied, listed are personal digital assistants (PDAs), digital still cameras, liquid crystal TVs and the like besides the personal computer 500 as shown in FIG. 10.

In the case of the aforementioned embodiment, for example, a data voltage outputting circuit has been described as the D/A converter. However, the present invention is not limited to this. The data voltage outputting circuit may be what outputs, to the data lines, data voltages based on the reference voltages, and may be an output circuit which outputs, for example, binary data.

In addition, each of the D/A converters 260 has been described as what select one gradient voltage out of a plurality of gradient voltages generated through dividing a reference voltage so as to output the selected one gradient voltage. However, the present invention is not limited to this. The D/A converters 260 may be what outputs data voltages based on the reference voltages. The D/A converter 260 may be an R-2R resistance ladder D/A converter, or may be any other D/A converter. Furthermore, the reference voltages of each of the D/A converters 260 have been described as including the upper limit reference voltage which determines the upper limit value of the gradient voltages and the lower limit reference voltage which determines the lower limit value of the gradient voltages. However, the present invention is not limited to this. The reference voltages of the D/A converter 260 may include only the upper limit reference voltage which determines the upper limit value of the gradient voltages.

Moreover, the compensation voltage outputting circuit 201 and the reference voltage distributing circuit 251 have been described as including divided resistances. However, the present invention is not limited to this. The compensation voltage outputting circuit and the reference voltage distributing circuit may be realized by use of another element having non-linear characteristics, or by use of a combination of active components.

Additionally, the electro-optic device has been described as being the liquid crystal display device 10. However, the present invention is not limited to this. The electro-optic device may be another type of display device such as an organic EL display device.

Heretofore, descriptions have been provided for the embodiment of the present invention. The present invention is not limited to the aforementioned embodiment. Various modifications and improvements can be added to the aforementioned embodiment. It is clearly understood, from the descriptions of the scope of the patent claims, that any other embodiment which will be carried out by adding such modifications and improvements to the aforementioned embodiment should be included in the technical scope of the present invention.

Although the preferred embodiment of the present invention has been described in detail, it should be understood that various changes, substitutions and alternations can be made therein without departing from spirit and scope of the inventions as defined by the appended claims.

What is claimed is:

1. A drive circuit for an electro-optic device which includes a plurality of scan lines, a plurality of data lines, and a plurality of pixel circuits arranged corresponding to intersections between individual ones of the scan lines and individual ones of the data lines, the drive circuit comprising:
a compensation voltage outputting circuit which, corresponding to a plurality of representative data lines selected out of the plurality of data lines, outputs compensation voltages obtained by compensating for differences in voltage characteristics among pixel circuits corresponding to the representative data lines;
a reference voltage distributing circuit for outputting a plurality of reference voltages on the basis of at least two of the compensation voltages; and
a data voltage outputting circuit for outputting data voltages based on the reference voltages respectively to the data lines.

2. The drive circuit for the electro-optic device according to claim 1,
wherein the data voltage outputting circuit comprises a D/A converter.

3. The drive circuit for the electro-optic device according to claim 2,
wherein the D/A converter selects a gradient voltage out of a plurality of gradient voltages generated through dividing the reference voltages.

4. The drive circuit for the electro-optic device according to claim 3,
wherein the reference voltages include an upper limit reference voltage for determining an upper limit value of the gradient voltages, and a lower limit reference voltage for determining a lower limit value of the gradient voltages.

5. The drive circuit for the electro-optic device according to claim 4,
wherein the reference voltages further include an intermediate reference voltage for determining voltages between the upper limit value and the lower limit value of the gradient voltages.

6. The drive circuit for the electro-optic device according to claim 1,
wherein the reference voltage distributing circuit comprises a plurality of divided resistances, each of which divides at least the two of the compensation voltages to generate the plurality of reference voltages.

7. The drive circuit for the electro-optic device according to claim 6,
wherein resistance values of the plurality of divided resistances are equal to one another.

8. The drive circuit for the electro-optic device according to claim 1,
wherein the compensation voltage outputting circuit includes a plurality of divided resistances, each of which divides a power voltage of the drive circuit to generate the compensation voltages.

9. An electro-optic device, comprising:
a display comprising a plurality of scan lines, a plurality of data lines, and a plurality of pixel circuits arranged corresponding to intersections between individual ones of the scan lines and individual ones of the data lines; and
a drive circuit comprising a compensation voltage outputting circuit which, corresponding to a plurality of representative data lines selected out of the plurality of data lines, outputs compensation voltages obtained by compensating for differences in voltage characteristics among pixel circuits corresponding to the representative data lines; a reference voltage distributing circuit for outputting a plurality of reference voltages on the basis of at least two of the compensation voltages; and a data voltage outputting circuit for outputting data voltages based on the reference voltages respectively to the data lines.

10. The electro-optic device according to claim 9, where said display is comprised of a liquid crystal display.

11. An electronic appliance, comprising:
a display comprising a plurality of scan lines, a plurality of data lines, and a plurality of pixel circuits arranged corresponding to intersections between individual ones of the scan lines and individual ones of the data lines; and
a drive circuit comprising a compensation voltage outputting circuit which, corresponding to a plurality of representative data lines selected out of the plurality of data lines, outputs compensation voltages obtained by compensating for differences in voltage characteristics among pixel circuits corresponding to the representative data lines; a reference voltage distributing circuit for outputting a plurality of reference voltages on the basis of at least two of the compensation voltages; and a data voltage outputting circuit for outputting data voltages based on the reference voltages respectively to the data lines.

12. The electronic appliance according to claim 11, where said display is comprised of a liquid crystal display.

13. A method to drive an electro-optic device comprised of a plurality of scan lines, a plurality of data lines, and an array of pixel circuits individual ones of which correspond to intersections between individual ones of the scan lines and individual ones of the data lines, the method comprising:
outputting compensation voltages generated to compensate for differences in voltage characteristics among pixel circuits corresponding to locations of pixel circuits within the array of pixel circuits;
outputting a plurality of reference voltages on the basis of at least two of the compensation voltages; and
outputting data voltages based on the reference voltages respectively to the data lines.

14. The method according to claim 13,
wherein the data voltages based on the reference voltages are outputted respectively to the data lines through a D/A converter.

15. The method according to claim 14,
where the D/A converter selects a gradient voltage out of a plurality of gradient voltages generated through dividing the reference voltages.

16. The method according to claim 15, where the reference voltages comprise an upper limit reference voltage for determining an upper limit value of the gradient voltages and a lower limit reference voltage for determining a lower limit value of the gradient voltages.

17. The method according to claim 16,
where the reference voltages further comprise an intermediate reference voltage for determining voltages between the upper limit value and the lower limit value of the gradient voltages.

18. The method according to claim 13,
where outputting the plurality of reference voltages comprises operating a plurality of series coupled voltage dividers.

19. The method according to claim 18,
where operating the plurality of series connected voltage dividers comprises applying a voltage to a plurality of equal valued series coupled resistances.

20. The method according to claim 13,
executed in an electronic device that comprises the electro-optic display device.
